(19) United States
(12) Patent Application Publication
(10) Pub. No.: US 2015/0166894 A1
(43) Pub. Date: Jun. 18, 2015

(54) LIQUID CRYSTAL DISPLAY PANEL AND LIQUID CRYSTAL DISPLAY APPARATUS

(71) Applicant: INNOLUX CORPORATION, Miaoli County (TW)

(72) Inventors: WOEI-HAW KHEW, Miaoli County (TW); SHU-HAN YU, Miaoli County (TW); KAI-NENG YANG, Miaoli County (TW); PI-YING CHUANG, Miaoli County (TW); CHIEN-HUNG CHEN, Miaoli County (TW)

(21) Appl. No.: 14/563,220

(22) Filed: Dec. 8, 2014

(30) Foreign Application Priority Data
Dec. 12, 2013 (TW) 102145913

(51) Int. Cl. C09K 19/56; G02F 1/1337

(52) U.S. Cl. CPC C09K 19/56; G02F 1/133723; G02F 1/1337

(57) ABSTRACT

A liquid crystal display panel includes a first substrate, a second substrate, and a liquid crystal layer. The first substrate includes a first alignment layer. The second substrate is disposed opposite to the first substrate, and includes a second alignment layer. The liquid crystal layer is disposed between the first substrate and the second substrate, and the first alignment layer and the second alignment layer are respectively contacting to the liquid crystal layer. The first alignment layer and the second alignment layer are polymerized respectively by a plurality of monomers with main chain containing benzene and mono-acrylate.

### FIELD OF THE INVENTION

The present invention relates to a display panel and device using the same, and more particularly, to a liquid crystal display (LCD) panel and an LCD apparatus using the same.

### BACKGROUND OF THE INVENTION

Among all the techniques relating to the manufacturing of liquid crystal display apparatuses, the liquid crystal alignment technique is considered to be one of the key factors for determining the image quality of a liquid crystal display apparatus, since an LCD panel can display high-quality images only if the initial arrangement of the liquid crystal material embedded inside the LCD panel can achieve a stable and uniform arrangement. Generally, there are layers inside the conventional LCD apparatus that are used for determine the orientation of liquid crystal molecules inside an LCD apparatus, whereas such layers are generally referred as alignment layers (ALs).

The one generally accepted technique for forming alignment layers is the rubbing method, which can cause liquid crystal molecules to be aligned homogeneously. For instance, polyimide (PI) films that have been processed by mechanical rubbing in a uniform singular direction can be used as liquid crystal alignment films in LCD apparatuses, since the parallel-arranged micro-grooves generated by this method can be used for orientating the liquid crystal molecules that later comes in contact with the rubbed surface.

Unfortunately, this rubbing method can generate electrostatic charges, both of which adversely affect thin-film transistors (TFTs) inside LCD apparatuses, while this method also generates dust from the cloth and PI which may adversely contaminate the liquid crystal material as well. Consequently, the quality of the resulting LCD apparatuses is decreased, not to mention that the additional process procedures required for this rubbing method can cause the cost and time for LCD manufacturing to increase.

Responsively, there is already a technique that eliminates the use of PI alignment films, which is referred as the PI-less process or PI-free process. Please refer to FIG. 1A and FIG. 1B, which shows a conventional PI-less process. As shown in FIG. 1A and FIG. 1B, a mixture of liquid crystal materials 1, polymer monomers 2 and bi-acrylate monomers 3 is disposed between two substrates 4 and then is exposed to the projection of a beam 5, by that the polymer monomers 2 and bi-acrylate monomers 3 are polymerized into two polymer alignment layers 6 on the surfaces of a liquid crystal layer of the liquid crystal materials 1 that are disposed engaging respectively to the two substrates 4, and thereby the orientation of the liquid crystal materials 1 is aligned accordingly. However, this process does not provide an alignment layer with a fixed, stable orientation of liquid crystal material, and thus the yield of the resulting LCD apparatuses can be adversely affected as there can be bright dots or bright lines to be generated easily on the resulting LCD apparatuses.

Therefore, it is in need of an LCD panel and an LCD apparatus using the same that can be manufactured by the use of a PI-less process, but without the aforesaid disadvantage of bright dot or bright line, and thus can be manufactured with satisfactory yield while preserving good image quality.

### SUMMARY OF THE INVENTION

The primary object of the present invention is to provide an LCD panel and an LCD apparatus using the same that can be manufactured by the use of a PI-less process, while also preventing the generation of bright dot or bright line in the LCD panel.

In an exemplary embodiment, the present invention provides an LCD panel, which comprises: a first substrate, configured with a first alignment layer; a second substrate, configured with a second alignment layer; and a liquid crystal layer, disposed between the first substrate and the second substrate; wherein, the first alignment layer and the second alignment layer are arranged respectively contacting to the liquid crystal layer, and the first alignment layer and the second alignment layer are polymerized respectively by a plurality of monomers with main chain containing benzene and mono-acrylate.

In another exemplary embodiment, the present invention provides an LCD apparatus, which comprises: a backlight module and an LCD panel, wherein the LCD panel further comprises: a first substrate, configured with a first alignment layer; a second substrate, configured with a second alignment layer; and a liquid crystal layer, disposed between the first substrate and the second substrate, wherein, the first alignment layer and the second alignment layer are arranged respectively contacting to the liquid crystal layer, and the first alignment layer and the second alignment layer are polymerized respectively by a plurality of monomers with main chain containing benzene and mono-acrylate.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1A shows a conventional PI-less process.

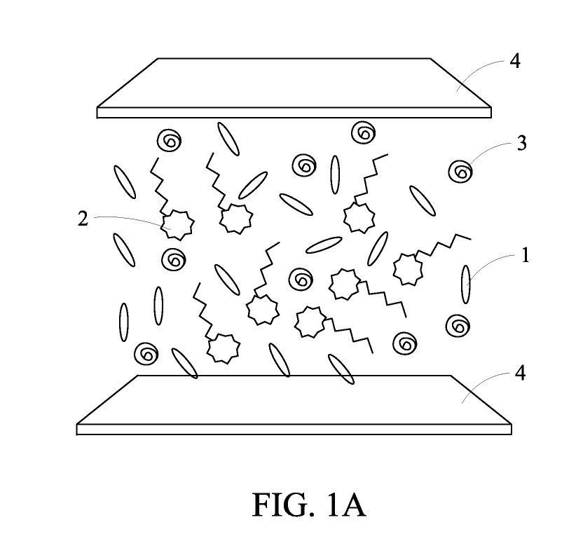

FIG. 1B shows a conventional PI-less process.

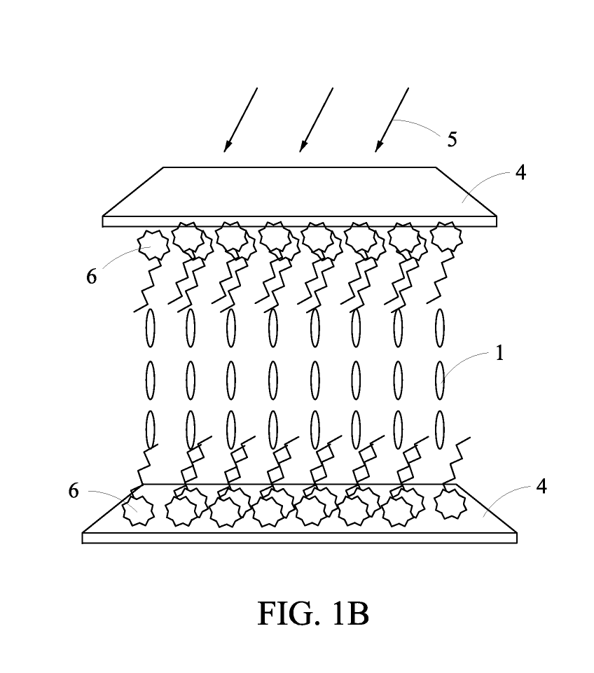

FIG. 2 is a schematic diagram showing an LCD panel according to an embodiment of the present invention.

FIG. 3 is a schematic diagram showing an LCD panel according to another embodiment of the present invention.

FIG. 4 is a schematic diagram showing an LCD apparatus according to an embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

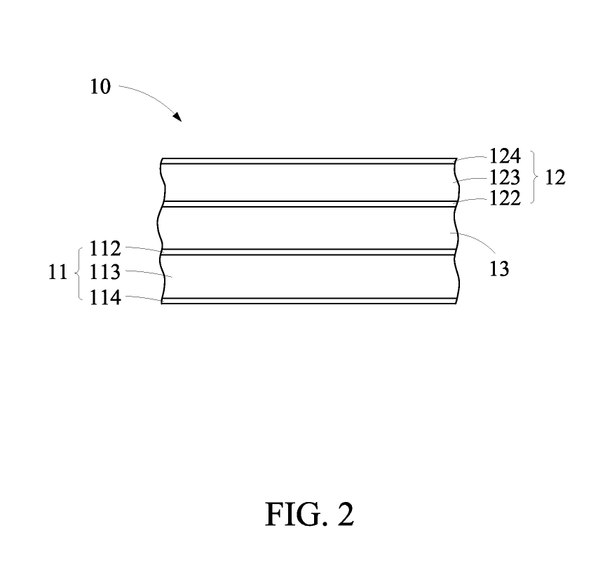

Please refer to FIG. 2, which is a schematic diagram showing an LCD panel according to an embodiment of the present invention. In this embodiment, an LCD panel 10 includes a first substrate 11, a second substrate 12, and a liquid crystal layer 13. The first substrate 11 includes a first alignment layer 112. The second substrate 12 is disposed opposite to the first substrate 11, and includes a second alignment layer 122. The liquid crystal layer 13 is disposed between the first substrate 11 and the second substrate 12, and the first alignment layer 112 and the second alignment layer 122 are arranged contacting to the liquid crystal layer 13. It is noted that the first substrate 11 can be a thin film transistor (TFT) substrate, and the second substrate 12 can be a color filter substrate. Moreover, the formation of the LCD panel 10 can have variations according to the applied technology, such as Color Filter on Array (COA), Black Matrix on Array (BOA), and TFT on CF, in which the TFT on CF can also be referred as TOC or Array on CF.

In addition, the first alignment layer 112 and the second alignment layer 122 are polymerized respectively by a plurality of monomers with main chain containing benzene and mono-acrylate via an irradiation process. In an embodiment of the present invention, the structural formula of each monomer with main chain containing benzene and mono-acrylate is represented as following:

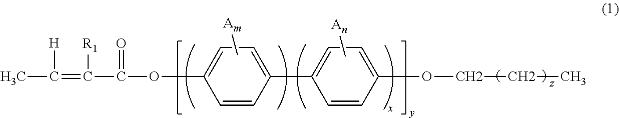

wherein,
A represents

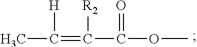

R₁ and R₂ represent H or CH₃;
m and n represent respectively a number selected from 0, 1, and 2;
x represent a number selected from 0, and 1; and
y and z represent an integer that is greater than or equal to 1.

In another embodiment, each monomer with main chain containing benzene and mono-acrylate is 1-crotonate-4-propoxybenzene, whose structural formula is represented as following:

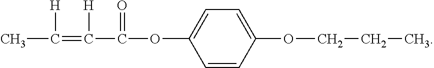 [SMILES: C/C=C\C(=O)Oc1ccc(OCCC)cc1]

In further another embodiment, each monomer with main chain containing benzene and mono-acrylate is 1,2-dicrotonate-4-propoxybenzene, whose structural formula is represented as following:

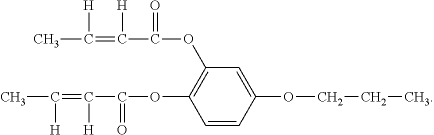 [SMILES: C/C=C\C(=O)Oc1ccc(OCCC)cc1OC(=O)/C=C\C]

Comparing to the polymer monomers 2 and bi-acrylate monomer 3 used in prior arts, each monomer with main chain containing benzene and mono-acrylate used in the present invention not only can replace the action of the prior polymer monomers 2 and bi-acrylate monomer 3, but also can achieve better and more stable alignment effect.

Moreover, the first substrate 11 can further be configured with a plate 113 and a polarizing element 114, and according to the various type of the LCD panel 10 or the difference in the technology that is to be applied, the plate 113 can include different elements. In one embodiment, the plate 113 can includes a substrate, a TFT array and a pixel electrode layer, etc., in which the substrate can be a glass substrate, a reinforced glass substrate or a plastic substrate. The polarizing element 114 can be disposed at a side of plate 113 that is disposed away from the liquid crystal layer 13, and the first alignment layer is formed in a thickness ranged between 10 Å and 100 Å.

Similarly, the second substrate 12 can further be configured with a plate 123 and a polarizing element 124, and according to the various type of the LCD panel 10 or the difference in the technology that is to be applied, the plate 123 can include different elements. In one embodiment, the plate 123 can includes a substrate, a Black Matrix on Array, a color filter layer and a common electrode layer, etc., in which the substrate can be a glass substrate, a reinforced glass substrate or a plastic substrate. The polarizing element 124 can be disposed at a side of plate 123 that is disposed away from the liquid crystal layer 13, and the second alignment layer is formed in a thickness ranged between 10 Å and 100 Å.

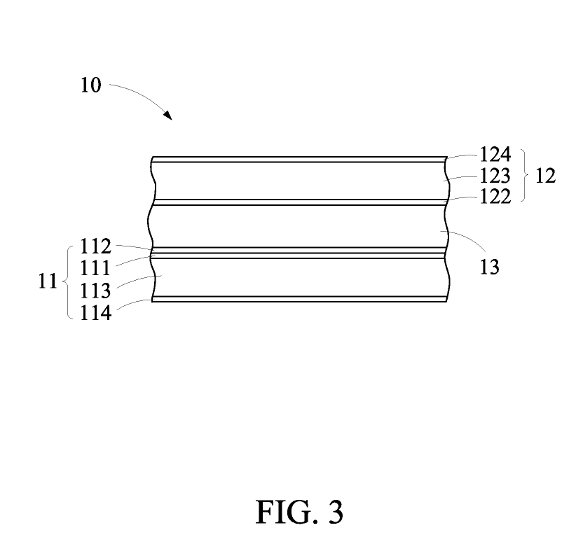

Please refer to FIG. 3, which is a schematic diagram showing an LCD panel according to another embodiment of the present invention. In this embodiment, one of the first substrate 11 and the second substrate 12 is configured with a third alignment layer 111, and moreover, one of the first alignment layer 112 and the second alignment layer 122 is disposed between the third alignment layer 111 and the liquid crystal layer 13. As shown in FIG. 3, the third alignment layer 111 is disposed on the first substrate 11 while allowing the first alignment layer 112 to be disposed between the third alignment layer 111 and the liquid crystal layer 13. In this embodiment, the third alignment layer 111 is substantially a polyimide (PI) alignment layer, and is formed in a thickness ranged between 450 Å and 1400 Å.

The following description relates to a method for manufacturing an exemplary LCD panel 10 of the present invention. Operationally, a first substrate 11 is aligned to a second substrate 12 so as to be laminated while allowing a liquid crystal mixture to be filled between the first and the second substrates 11, 12 by injection or by one-drop-fill (ODF). It is noted that the liquid crystal mixture contains a liquid crystal material, a plurality of monomers with main chain containing benzene and mono-acrylate and a photoinitiator. The structural formula of each monomer with main chain containing benzene and mono-acrylate is provided hereinbefore and thus will not be described further herein, and the photoinitiator can include a phenyl ketone, such as 1-hydroxy-cyclohexylphenyl-ketone, with a structural formula of:

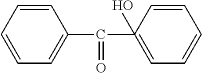

It is noted that the weight ratio of the monomers with main chain containing benzene and mono-acrylate in the liquid crystal mixture is ranged between 1.5% and 3.6%, while the weight ratio of the photoinitiator in the liquid crystal mixture is smaller than 1%; and preferably, the weight ratio of the photoinitiator in the liquid crystal mixture should be ranged between 0.1% and 0.2%.

In another embodiment, the first alignment layer 112 and the second alignment layer 122 can be polymerized respectively by a plurality of monomers with main chain containing benzene and mono-acrylate and a plurality of dual acrylic monomers, in which the weight ratio of the compound of the monomers with main chain containing benzene and mono-acrylate and the dual acrylic monomers in the liquid crystal mixture is smaller than 4%, whereas preferably, the weight ratio of the monomers with main chain containing benzene and mono-acrylate in the liquid crystal mixture should be ranged between 1.5% and 3.6%, and the weight ratio of the dual acrylic monomers in the liquid crystal mixture should be ranged between 0.2% and 0.64%. Moreover, the weight ratio of the photoinitiator in the liquid crystal mixture is smaller than 1%; and preferably, the weight ratio of the photoinitiator in the liquid crystal mixture should be ranged between 0.1% and 0.2%.

After the aligning and laminating of the first substrate 11 and the second substrate 12, an electric field is exerted upon the pixel electrodes and common electrodes of the first substrate 11 and the second substrate 12 for orientating the liquid crystal molecule to a designated direction, while irradiating a beam for illuminating the first substrate 11 and the second substrate 12 during the exerting of the electric field. The beam can be emitted from a light source of wide wavelength range, such as an UV ultra high pressure mercury lamp, an UV high pressure mercury lamp, or an UV ultra medium pressure mercury lamp, with a wavelength ranged between 100 nm and 400 nm By the irradiation of the beam, the monomers are polymerized so as to form a first alignment layer 112 and a second alignment layer respectively on the first substrate 11 and the second substrate 12 while enabling the liquid crystal mixture to be transformed into a liquid crystal layer 13. However, there can be some monomers left in the liquid crystal layer 13.

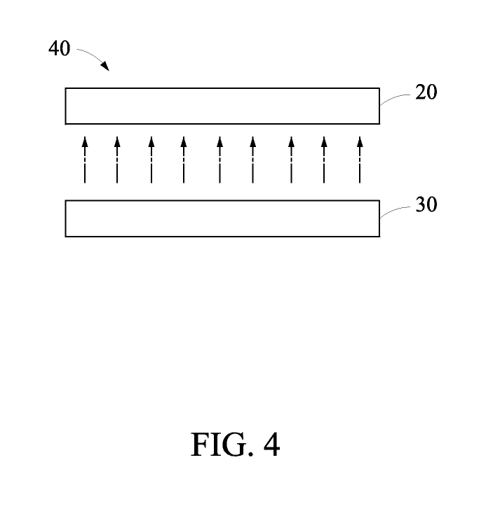

Please refer to FIG. 4 is a schematic diagram showing an LCD apparatus according to an embodiment of the present invention. As shown in FIG. 4, an LCD apparatus 40 comprises: an LCD panel 20 and a backlight module 30. It is noted that the LCD panel 20 can be any one of the LCD panel mentioned in the above embodiment of the present invention, whereas the LCD panel 20 is disposed opposite to the backlight module 30. Moreover, the backlight module 30 is provided for emitting a light to the LCD panel 20, whereas there is no restriction to the type of the backlight module 30, that it can be a direct-type backlight module or a side-edge backlight module.

To sum up, in the LCD panel and the LCD apparatus of the present invention, the conventional mixture of polymer monomers 2 and bi-acrylate monomers 3 is replaced by a plurality of monomers with main chain containing benzene and mono-acrylate, and thereby, the orientation effect of a PI-less process can be enhanced and consequently, the generation of bright dot or bright line in the resulting LCD panels can be reduced, and thus the production yield as well as the image quality are enhanced.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A liquid crystal display panel, comprising:
a first substrate, configured with a first alignment layer;
a second substrate, configured with a second alignment layer; and
a liquid crystal layer, disposed between the first substrate and the second substrate, the first alignment layer and the second alignment layer are arranged respectively contacting to the liquid crystal layer;
wherein, the first alignment layer and the second alignment layer are polymerized respectively by a plurality of monomers with main chain containing benzene and mono-acrylate.

2. The liquid crystal display panel of claim 1, wherein the structural formula of each monomer with main chain containing benzene and mono-acrylate is represented as following: 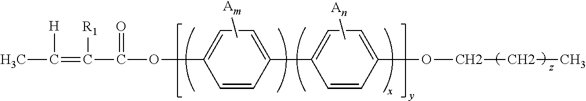
wherein,
A represents 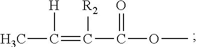
R₁ and R₂ represent H or CH₃;
m and n represent respectively a number selected from 0, 1, and 2;
x represent a number selected from of 0, and 1;
y and z represent an integer that is greater than or equal to 1.

3. The liquid crystal display panel of claim 1, wherein the monomers is 1-crotonate-4-propoxybenzene, whose structural formula is represented as following:

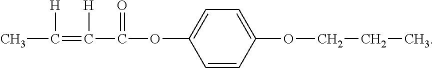 [SMILES: C/C=C\C(=O)Oc1ccc(OCCC)cc1]

4. The liquid crystal display panel of claim 1, wherein the monomers is a 1,2-dicrotonate-4-propoxybenzene, whose structural formula is represented as following:

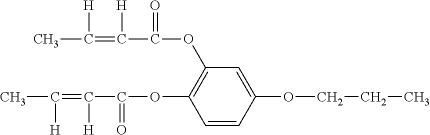 [SMILES: C/C=C\C(=O)Oc1ccc(OCCC)cc1OC(=O)/C=C\C]

5. The liquid crystal display panel of claim 1, wherein each of the first alignment layer and the second alignment layer is formed in a thickness ranged between 10 Å and 100 Å.

6. The liquid crystal display panel of claim 1, wherein one of the first substrate and the second substrate is configured with a third alignment layer.

7. The liquid crystal display panel of claim 6, wherein one of the first alignment layer and the second alignment layer is disposed between the third alignment layer and the liquid crystal layer.

8. The liquid crystal display panel of claim 6, wherein the third alignment layer is a polyimide (PI) alignment layer.

9. The liquid crystal display panel of claim 6, wherein the third alignment layer is formed in a thickness ranged between 450 Å and 1400 Å.

10. A liquid crystal display apparatus, comprising:
a backlight module; and
a liquid crystal display panel, further comprising:
a first substrate, configured with a first alignment layer;
a second substrate, and configured with a second alignment layer; and
a liquid crystal layer, disposed between the first substrate and the second substrate, the first alignment layer and the second alignment layer are arranged respectively contacting to the liquid crystal layer;
wherein, the first alignment layer and the second alignment layer are polymerized respectively by a plurality of monomers with main chain containing benzene and mono-acrylate.

11. The liquid crystal display apparatus of claim 10, wherein the structural formula of each monomer with main chain containing benzene and mono-acrylate is represented as following: 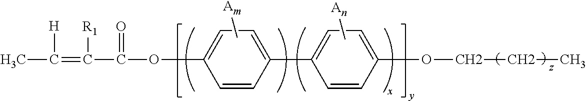
wherein,
A represents 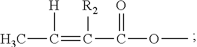
R₁ and R₂ represent H or CH₃;
m and n represent respectively a number selected from 0, 1, and 2;
x represent a number selected from of 0, and 1;
y and z represent an integer that is greater than or equal to 1.

12. The liquid crystal display apparatus of claim 10, wherein the monomers is 1-crotonate-4-propoxybenzene, whose structural formula is represented as following:

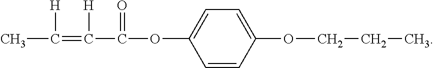 [SMILES: C/C=C\C(=O)Oc1ccc(OCCC)cc1]

13. The liquid crystal display apparatus of claim 10, wherein the monomers is a 1,2-dicrotonate-4-propoxybenzene, whose structural formula is represented as following:

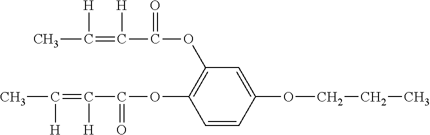 [SMILES: C/C=C\C(=O)Oc1ccc(OCCC)cc1OC(=O)/C=C\C]

14. The liquid crystal display apparatus of claim 10, wherein each of the first alignment layer and the second alignment layer is formed in a thickness ranged between 10 Å and 100 Å.

15. The liquid crystal display apparatus of claim 10, wherein one of the first substrate and the second substrate is configured with a third alignment layer.

16. The liquid crystal display apparatus of claim 15, wherein one of the first alignment layer and the second alignment layer is disposed between the third alignment layer and the liquid crystal layer.

17. The liquid crystal display apparatus of claim 15, wherein the third alignment layer is a polyimide (PI) alignment layer.

18. The liquid crystal display apparatus of claim 15, wherein the third alignment layer is formed in a thickness ranged between 450 Å and 1400 Å.
